(19) United States
(12) Patent Application Publication
(10) Pub. No.: US 2008/0297491 A1
(43) Pub. Date: Dec. 4, 2008

(54) Stylus for a touch-screen device

(76) Inventor: Gordon K. Adkins, St. George Island, FL (US)

Correspondence Address: John Wiley Horton, Attorney;Pennington, Moore, Wilkinson, Bell & Dunbar, P.A., 2nd Floor, 215 S. Monroe St., Tallahassee, FL, 32301, US

(21) Appl. No.: 11/977,966

(22) Filed: Oct. 26, 2007

Related U.S. Application Data
(63) Continuation-in-part of application No. 11/807,417, filed on May 29, 2007.

(51) Int. Cl. G06F 3/033

(52) U.S. Cl. 345/179

(57) ABSTRACT

A stylus for use in operating any small device requiring contact for inputting commands. The stylus is comprised of a wrap and a conductive contactor. The wrap encircles and engages a user's digit. The conductive contactor is positioned to easily contact a touch-screen device when the wrap is placed on a user's digit. The conductive contactor may be located on the end of a tongue, a tip, or a combination of a tongue and a tip.

### CROSS-REFERENCES TO RELATED APPLICATIONS

This non-provisional application is a continuation-in-part of U.S. patent application Ser. No. 11/807,417 (filed on May 29, 2007). The two applications list the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of devices made for operation of touch responsive user interfaces. More specifically, the invention comprises a stylus modified for attachment to a user's thumb or finger so as to operate a device using a touch-screen or small buttons.

2. Description of the Related Art

Personal Digital Assistants (PDA's) including electronic organizers, palmtops, and other hand-held devices are in wide use today. PDA's typically have a touch-screen and/or small buttons allowing data entry and selections. Generally a user would operate the touch-screen and small buttons with the provided stylus (in the shape of a small pen) or the user's finger.

A small pen-shaped stylus is utilized in much the same way as a pen. The stylus allows the user to make contact with the touch-screen commands or small buttons. However, the small size of the stylus and screen makes these operations awkward. Additionally, the user must hold the device in one hand and operate the stylus with the other hand, leaving no hand free. Using a fingertip in place of the stylus is also difficult, as the tip of a finger is broad compared to the small touch-screen command buttons. Using a stylus instead of a finger is preferable, since the transfer of natural oils from a user's finger onto the touch-screen shortens the life of the touch-screen.

The iPhone, created and sold by Apple, Inc., of Cupertino, Calif., is becoming a popular replacement for traditional PDA devices. Although some aspects of the iPhone's functionality are similar to traditional PDAs, there are some significant differences. One of these differences is the iPhone's multi-touch-screen technology. The iPhone touch-screen, unlike current PDA touch-screen technology, utilizes a layer of capacitive material to sense contact. If the user touches the capacitive material the amount of charge at the contact point changes. The capacitive touch screen monitors that change in the electrical current to determine the point of user contact on the screen. Like a traditional PDA, the individual touch-screen commands are cumbersome to contact by way of the user's finger, especially when trying to compose an e-mail on the virtual keyboard. However, unlike a traditional PDA, a prior art stylus will not interact with the capacitive touch-screen, due to the mechanical and electrical properties of the stylus.

A stylus allowing one-handed operation of a conventional touch-screen device and operational interaction with a capacitive touch-screen device would be desirable. Unfortunately, these dual requirements mean that the point of the stylus which actually contacts the screen will need to have different characteristics for the different applications. The present invention achieves this objective by using appropriate materials for the contacting point, as well as appropriate geometry.

### BRIEF SUMMARY OF THE INVENTION

The present invention comprises a stylus for use in the operation of any small device requiring the actuation of small buttons or the entry of touch-screen commands. The stylus is comprised of a wrap and an attached stylus tip. The wrap encircles a user's digit thereby attaching the stylus to the digit. The tip of the stylus extends from the central axis of the user's digit so that it may be conveniently used to make contact with the screen or buttons on a hand-held device.

In the preferred embodiments, the tip incorporates an attachment which specifically configures it for operation with a particular device. The attachments preferably have different mechanical and electrical properties, with the attachment of the most preferred embodiment having a pliable conductive surface configured to interact with a capacitive touch-screen device.

### BRIEF DESCRIPTION OF THE SEVERAL VIEWS OF THE DRAWINGS

FIG. 1 is a perspective view, showing the present invention in relation to a user's thumb.

FIG. 2 is a perspective view, showing the present invention being used on a hand-held device with one hand.

FIG. 3 is a perspective view, showing one embodiment of the present invention.

FIG. 4 is a perspective view, showing the present invention attached to a hand-held device by way of a lanyard.

FIG. 5 is a perspective view, showing a means of attaching the present invention to a hand-held device by way of a small magnet.

FIG. 6 is a perspective view, showing alternative embodiments for the position of the tip of the stylus.

FIG. 7 is a side view, showing several possible embodiments of the invention with different angles of the tip of the stylus in relation to the tongue and central axis of the thumb.

FIG. 8 is a perspective view, showing an alternative embodiment of the present invention.

FIG. 9 is a perspective view, showing an alternative embodiment of the present invention with multiple tips.

FIG. 10 is a perspective view, showing the user's thumb rotation as it moves across touch-screen of hand-held device.

FIG. 11 is a perspective view, showing an alternative embodiment of the present invention with multiple tips.

FIG. 12 is a perspective view, showing an alternative embodiment of the present invention with a concave cup at the narrow end of tip.

FIG. 13 is a perspective view, showing a concave cup at the end of a stylus pen.

FIG. 14 is a perspective view, showing an alternative embodiment of the present invention with an angular tip.

FIG. 15 is a perspective view, showing the user operating a touch-screen device with two digits and two styluses.

FIG. 16 is a perspective view, showing the preferred embodiment of the present invention.

FIG. 17 is a perspective view, showing a cap with a concave cup configured to attach to the present invention.

FIG. 18 is a cross section view, showing a cap with a concave cup configured to attach to the present invention.

FIG. 19 is a perspective view, showing the cap with a concave cup attached to the present invention.

FIG. 20 is a perspective view, showing a cap with a conductive contactor configured to attach to the present invention.

FIG. 21 is a sectional view of the cap with a conductive contactor.

FIG. 21B is a more detailed sectional view of the conductive contactor, showing the use of a resilient material covered by a pliable conductive layer.

FIG. 22 is a perspective view, showing the cap with a conductive contactor configured to attach to the present invention.

FIG. 23 is a perspective view, showing a prior art stylus incorporating a conductive contactor on its tip.

FIG. 24 is a perspective view, showing a stylus with a conductive contactor attached to a tongue.

### REFERENCE NUMERALS IN THE DRAWINGS

| | | | |
|---|---|---|---|
| 10 | tip | 12 | tongue |
| 14 | wrap | 16 | lanyard hole |
| 18 | digit | 20 | hand-held device |
| 22 | lanyard | 24 | touch-screen |
| 26 | central axis | 28 | angle of descent |
| 30 | crossbar | 32 | stylus |
| 34 | magnet | 36 | hand |
| 38 | hook | 40 | concave cup |
| 42 | pen | 44 | nipple |
| 46 | tip body | 48 | conductive contactor |
| 50 | cap | 52 | resilient material |
| 54 | pliable conductive layer | | |

### DETAILED DESCRIPTION OF THE INVENTION

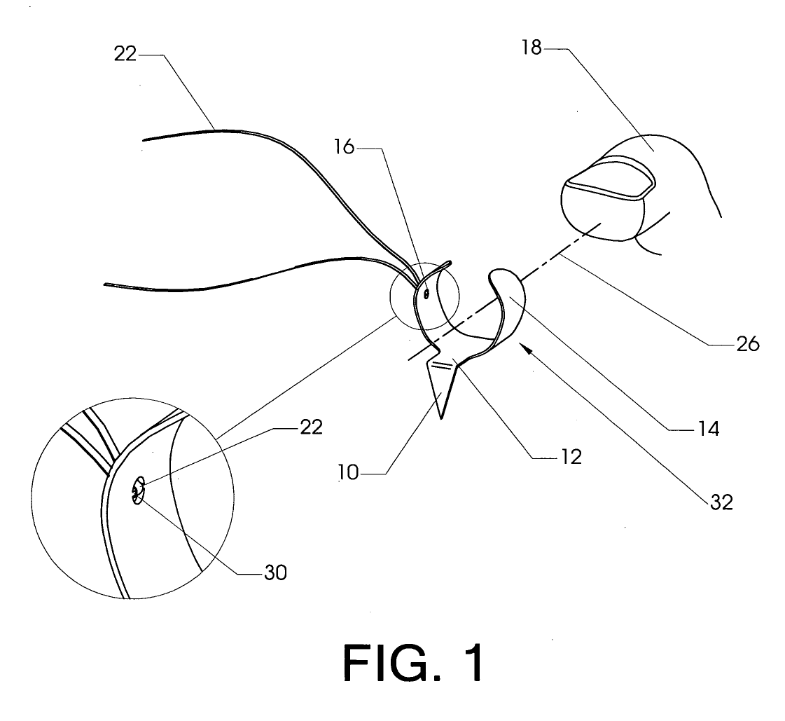

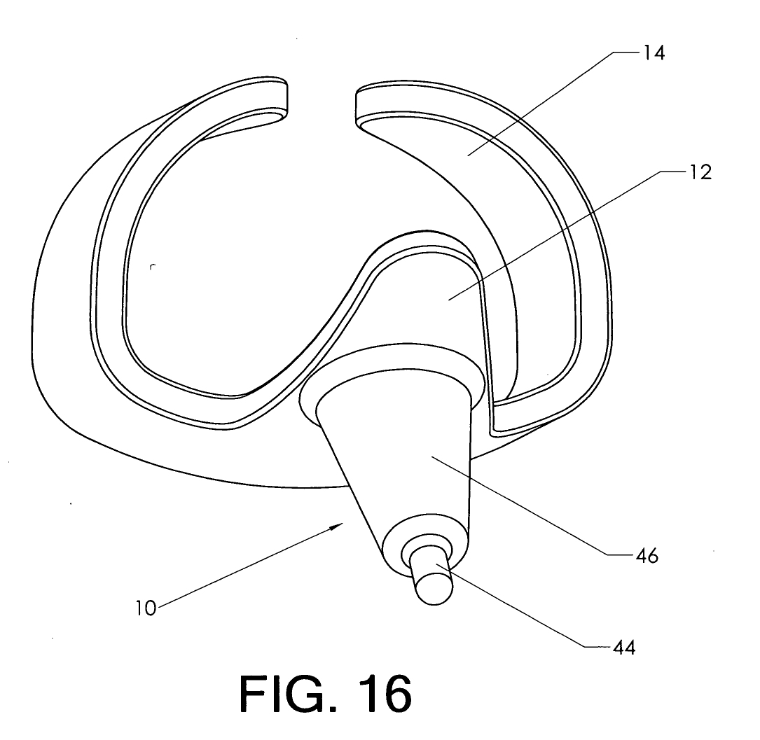

FIGS. 1 through 15 illustrate the invention that is described and claimed in copending U.S. application Ser. No. 11/807,417 (filed on May 29, 2007). Many of the features claimed in the present application are common to those disclosed in Ser. No. 11/807,417. FIGS. 16-23 illustrate features that are new in this application. A full discussion of the features originally contained in Ser. No. 11/807,417 is included in this application so that the reader will not be forced to refer to external materials in reviewing this disclosure. The reader should also bear in mind that any of the new features disclosed in FIGS. 16-23 could be combined with the features disclosed in FIGS. 1-15.

FIG. 1 shows a stylus 32 in position to be installed on a user's digit 18 (preferably a thumb but possibly a finger or even a toe). This view shows digit 18 of the user aligned with stylus 32. Wrap 14 is configured to encircle a user's digit 18 along central axis 26. “Digit” for purposes of this invention is defined as any finger or thumb on either hand of the user or any toe on either foot of the user. Digit 18 of the user slides or fits into wrap 14. Wrap 14 can be made of any material. Wrap encircles digit 18 and allows the user to adjust the grip of wrap 14. For example, wrap 14 can be made up of plastic which frictionally engages digit 18 or of a deformable material which the user presses inward to clamp to digit 18, such as certain metals.

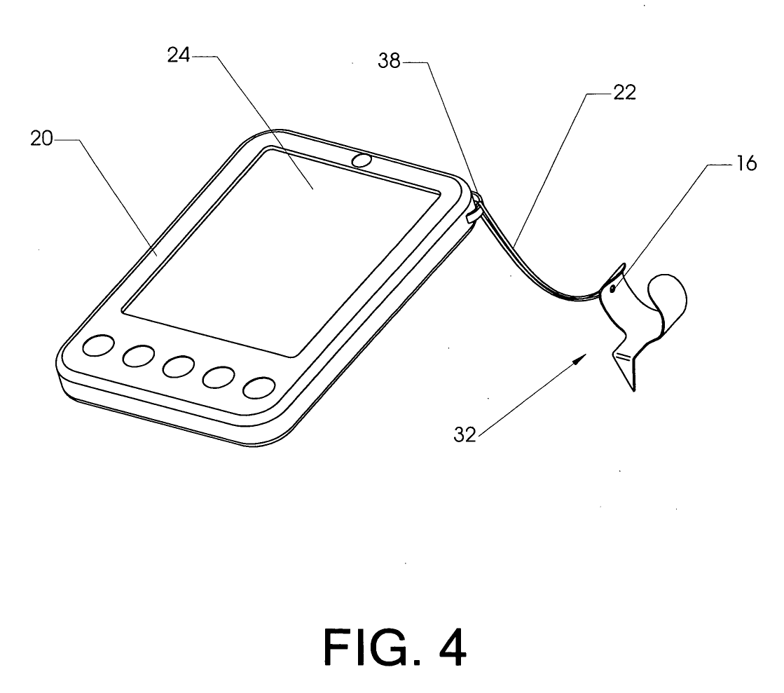

Wrap 14 preferably contains a lanyard hole 16 through which a lanyard 22 can be threaded. In one embodiment of the present invention lanyard hole 16 contains a crossbar 30 around which lanyard 22 is threaded. As the reader will observe in FIG. 4, lanyard 22 can be attached to hook 38 located on hand-held device 20 to prevent the user from losing or dropping the small stylus 32. Returning to FIG. 1, tongue 12 of stylus 32 extends outward from wrap 16 in a direction approximately parallel to central axis 26 of the digit 18. Tip 10 attaches to any point on tongue 12. Tip 10 extends downward from central axis 26 of digit 18.

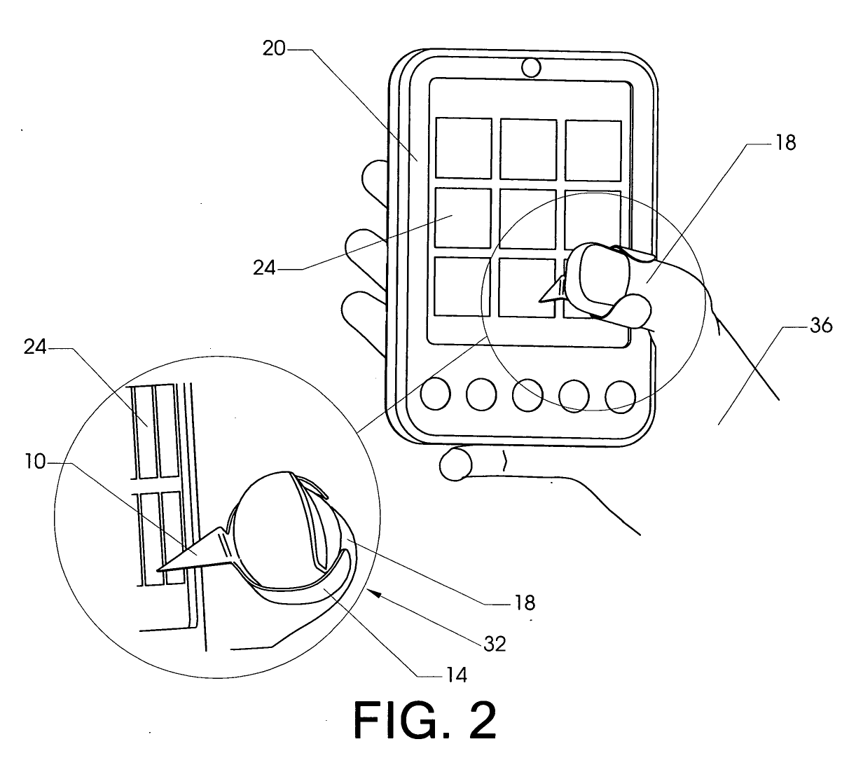

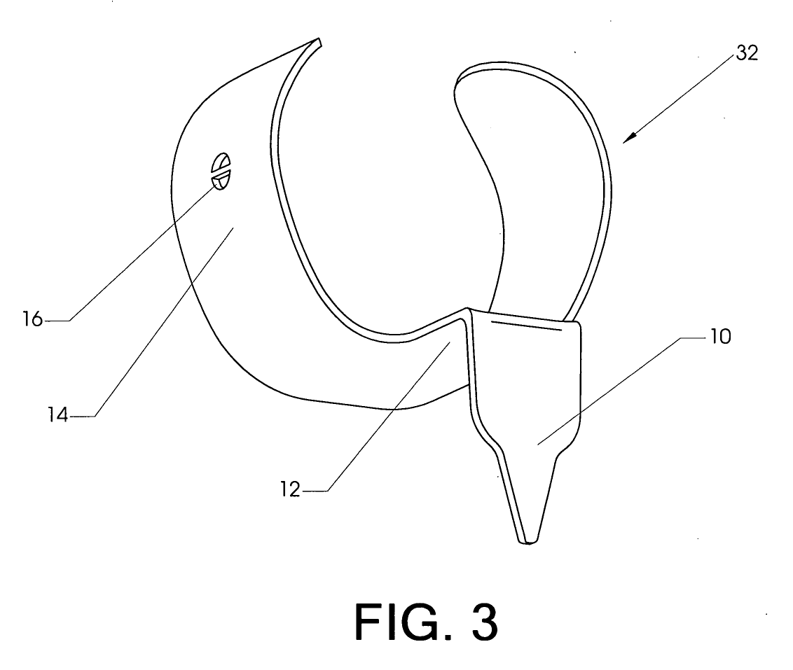

Continuing now to describe the general features common to both Ser. No. 11/807,417 and the present disclosure, FIG. 2 portrays how the hand-held device 20 is fully operative with only one hand 36 when utilizing stylus 32. Hand 36 cradles hand-held device 20 while digit 18, preferably the user's thumb, operates touch-screen 24. As shown in the detail view of FIG. 2, stylus 32 is secured to digit 18 by wrap 14. The user can freely move digit 18 and stylus 32 around touch-screen 24. Because tip 10 descends downward with respect to central axis of digit 18, the user can comfortably operate touch-screen 24 without awkwardly bending digit 18 to make contact with touch-screen 24. By eliminating the need to hold digit 18 in a constant bent position, the invention allows the user to operate hand-held device 20 comfortably for extended periods of time. FIG. 3 illustrates some structural details. This view of stylus 32 better illustrates the descent of tip 10 away from tongue 12 of stylus 32. The tip is thereby displaced a distance from the user's digit, which makes the stylus easier to use.

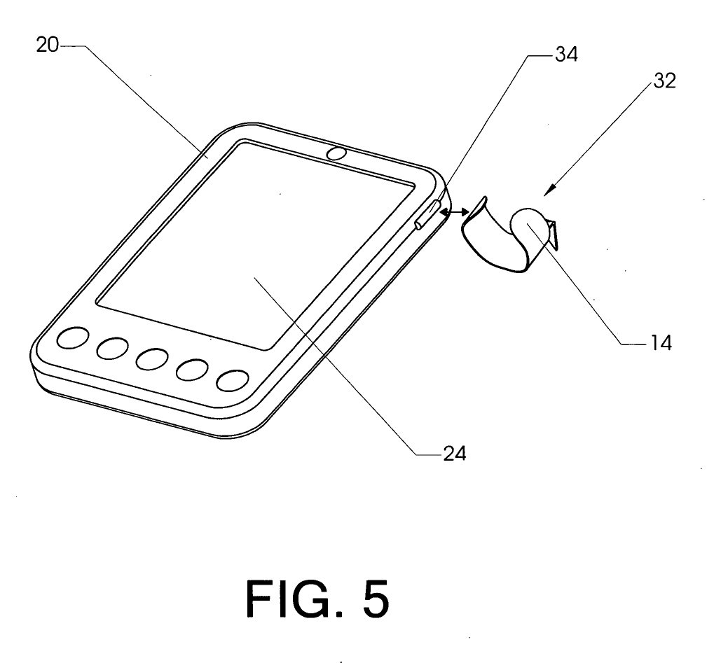

As the reader will observe in FIG. 4 and FIG. 5, there can be several different ways of attaching stylus 32 to hand-held device 20. In FIG. 4 lanyard 22 attaches stylus 32 to hook 38 on hand-held device 20. FIG. 5, on the other hand, illustrates stylus 32 lining up with magnet 34. Magnet 34 is located on the side of hand-held device 20 and is preferably a neodymium magnet which attracts stylus 32. Stylus 32 is either made of a material which inherently engages magnet 34 or a strip of material which engages magnet is permanently attached to stylus 32.

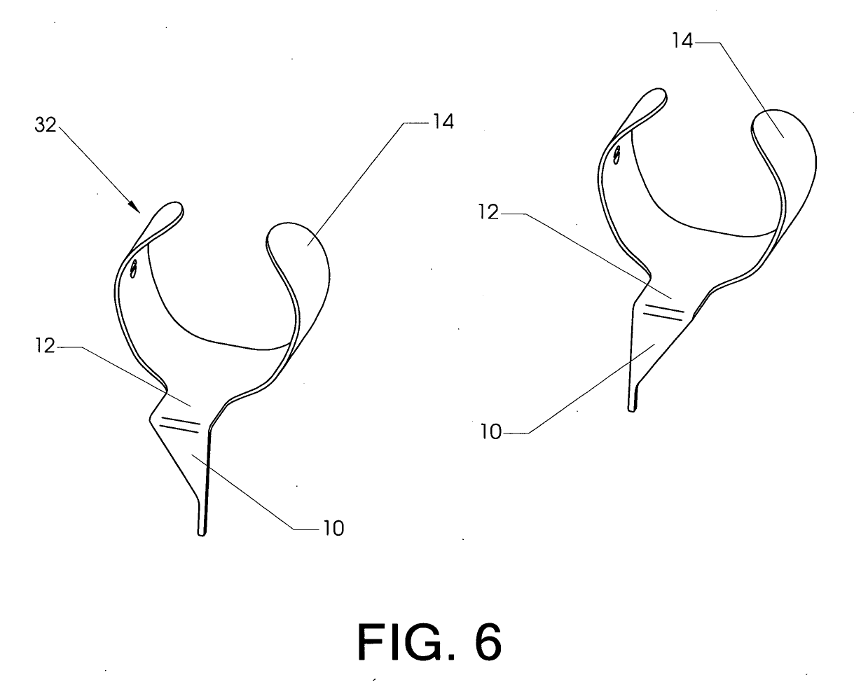

FIG. 6 illustrates an alternative embodiment of the stylus where tip 10 of stylus 32 is offset to the right or the left of tongue 12. As the position of tip 10 changes, the pressure on touch-screen 24 may vary according to how each particular user aligns digit 18 with hand-held device 20. The different available positions of tip 10 allow each individual user to choose a stylus incorporating the most comfortable tip position according to each user's preference.

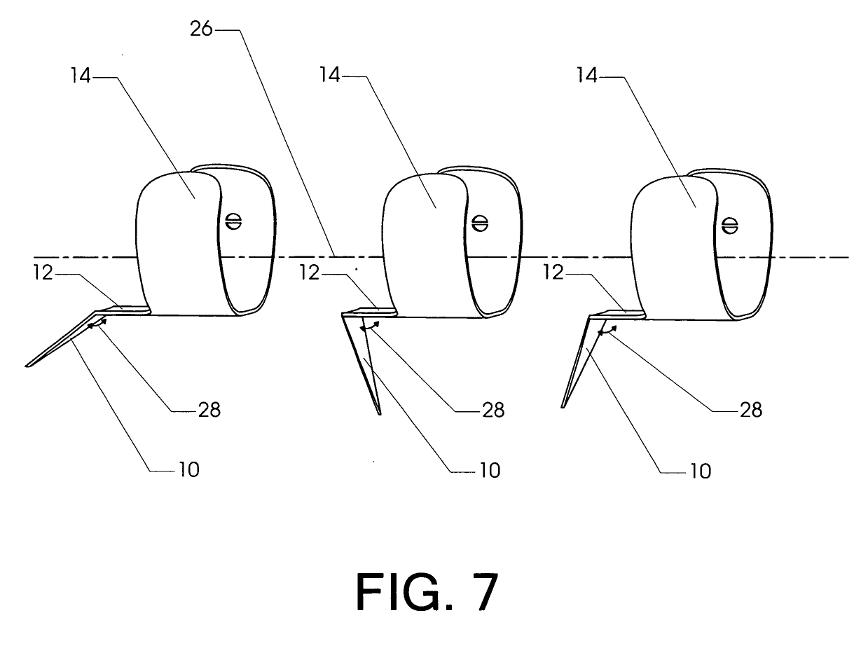

FIG. 7 shows a side view of three different embodiments of the present invention. Each embodiment includes a different angle of descent 28. Angle of descent 28 is created by the intersection between the plane of tip 10 and the plane of tongue 12, which is also approximately parallel to the base of wrap 14 and central axis 26. As the reader will observe, angle of descent 28 can be acute, obtuse or 90 degrees. Similar to the choice of tip position, the user would be able to choose the most comfortable angle of descent 28 dependent on the user's personal preference.

As FIG. 6 and FIG. 7 show, the orientation of tip 10 to tongue 12 and base of wrap 14 can be significantly varied. However, in each variation tip 10 descends downward from the central axis of the user's digit. This ensures that the user, using only one hand, can easily interact with touch-screen 24.

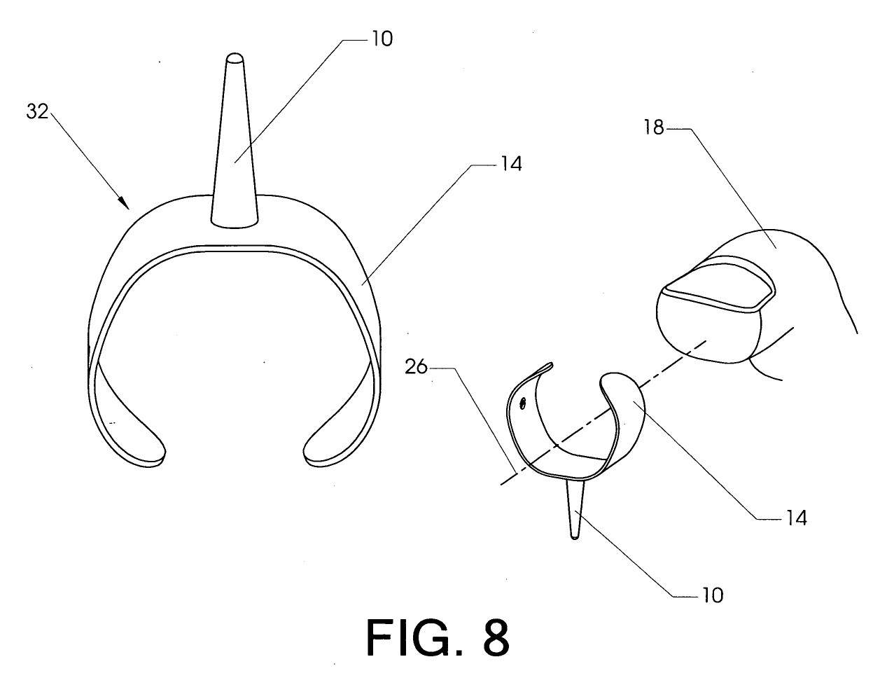

FIG. 8 illustrates the use of a descending tip that is attached directly to wrap 14 instead of tongue 12. The narrow end of tip 10 ends in a convex cup which is used to communicate with hand-held device 20. The reader will observe that tip 10 still descends downward away from central axis 26 of the user's digit 18, though the tongue has been omitted. The use of the device is essentially the same.

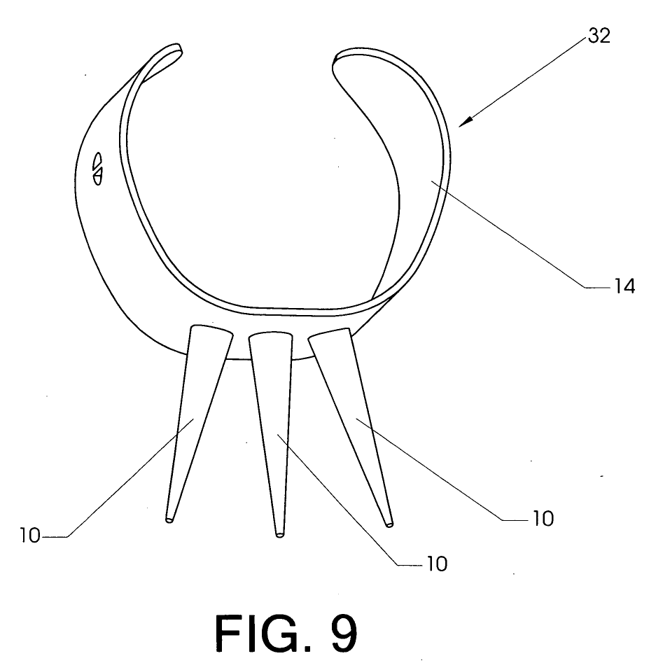

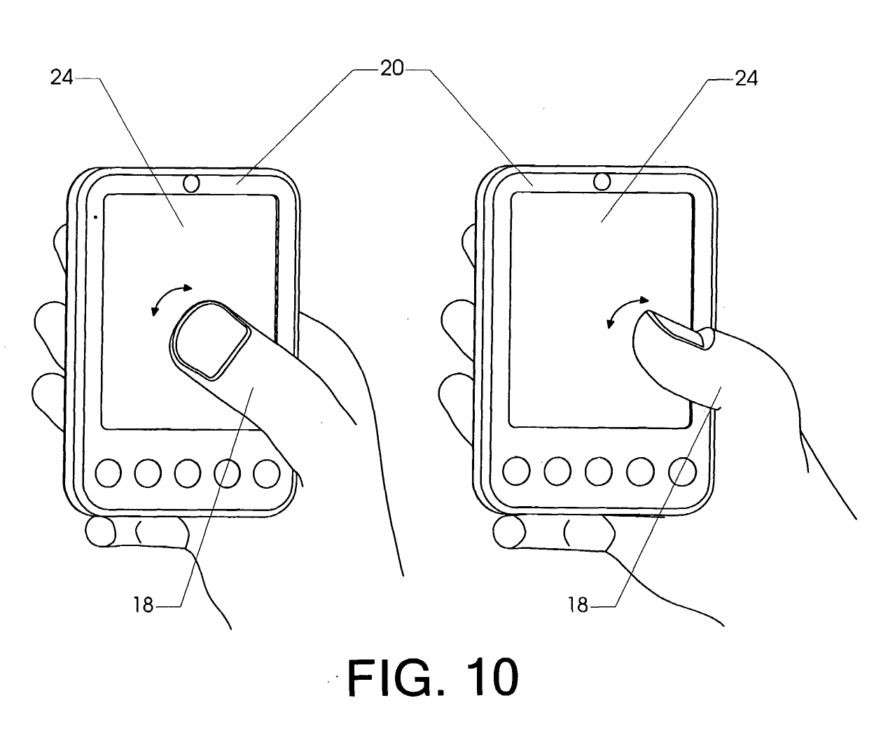

FIG. 9 illustrates another embodiment which has more than one tip 10 descending downward away from central axis 26 of the user's digit 18. By having a second or third tip 10 protruding from wrap 14, the user will be able to operate hand-held device 20 with greater ease and comfort since the thumb rotates while moving across touch-screen 24. This natural rotation of the user's thumb as it moves across the touch-screen is illustrated in FIG. 10. As the user's digit 18 rotates the middle tip 10 may no longer provide the best point at which to contact touch-screen 24.

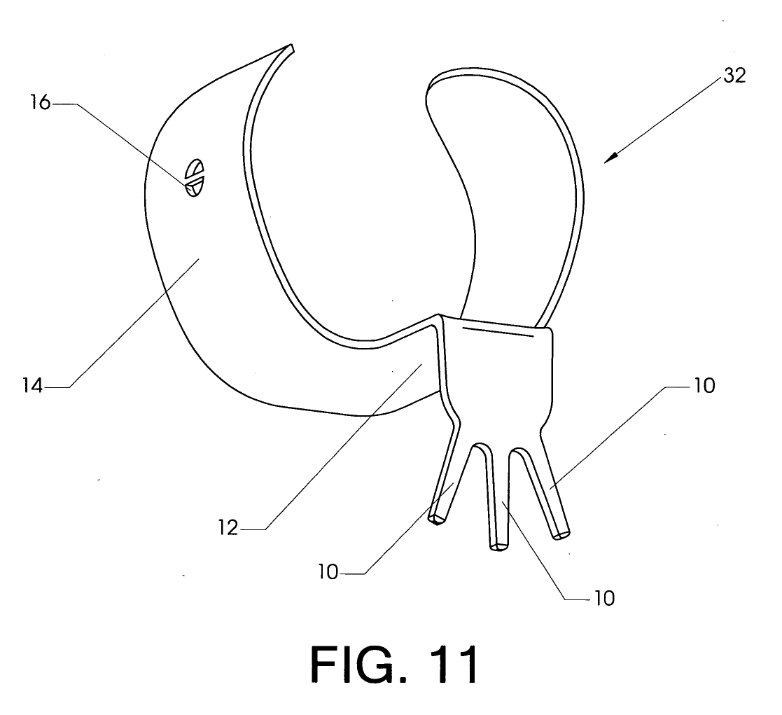

FIG. 10 exemplifies the rotation of the user's thumb. As digit 18 moves across touch-screen 24 digit 18 rotates in relation to touch-screen 24. By having an additional tip offset to the right of user's thumb as seen in FIG. 9 and FIG. 11, the user can contact touch-screen 24 with the additional tip 10 without having to overcompensate to continue to use the middle tip 10. Alternatively, a left-handed individual would benefit from an additional tip offset to the left of user's left thumb. The additional tip 10 will reduce the amount of movement required to operate hand-held device 20. The reduction in overall movement, particularly the bending motion, will also reduce the fatigue which can occur during the operation of hand-held device 20. FIG. 11 shows a version in which multiple tips descend from a single tongue.

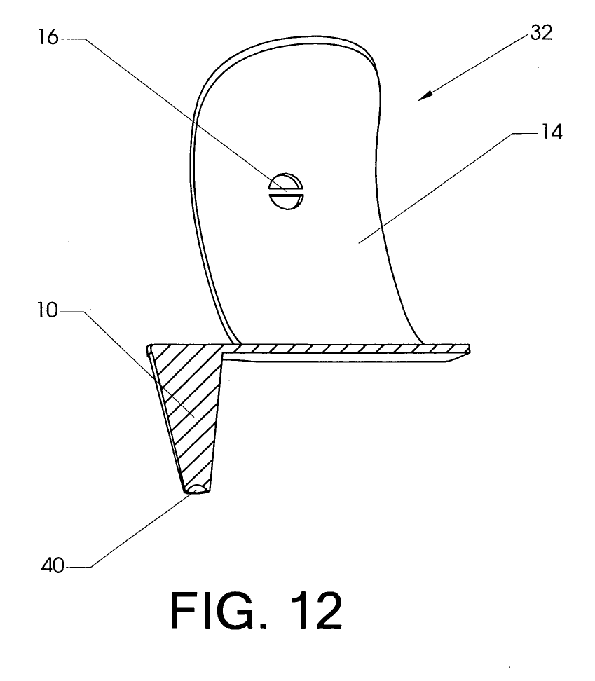

FIG. 12 illustrates an alternative configuration for the tip geometry. Some devices require the actuation of buttons (such as a miniature keyboard). These buttons are often dome-shaped. The use of a convex tip with the dome-shaped buttons can be difficult. Accordingly, in such applications, it is preferable to provide a concave tip. FIG. 12 is a sectional view illustrating such a tip. Concave cup 40 allows the user to more easily engage a domed structure located on hand-held device 20. In one embodiment the surface area of concave cup 40 would be made up of a rubber material to increase the gripping ability of stylus 32. Concave cup 40 could be applied to any stylus tip.

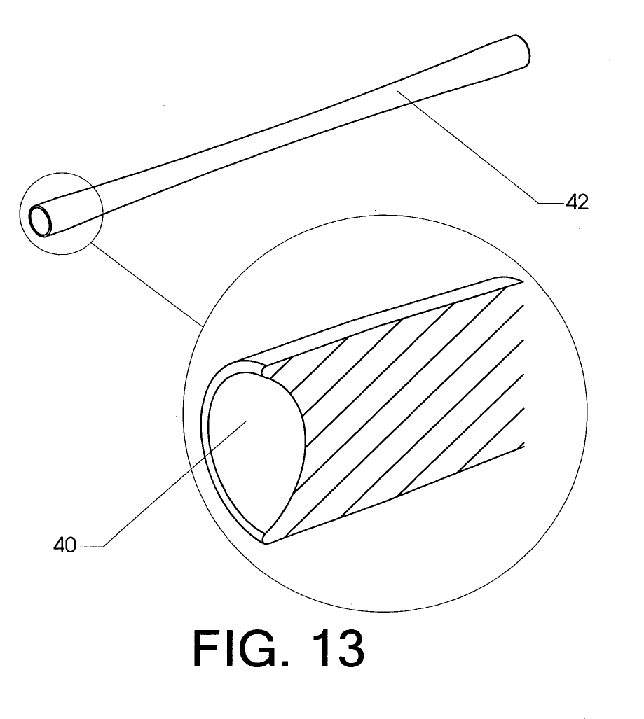

FIG. 13 shows concave cup 40 located at the end of a stylus pen 42. Concave cup 40 allows the user to more easily rotate a domed structure as the user moves pen 42. However, although the device of FIG. 13 is disclosed for informational purposes, it is not claimed in this application.

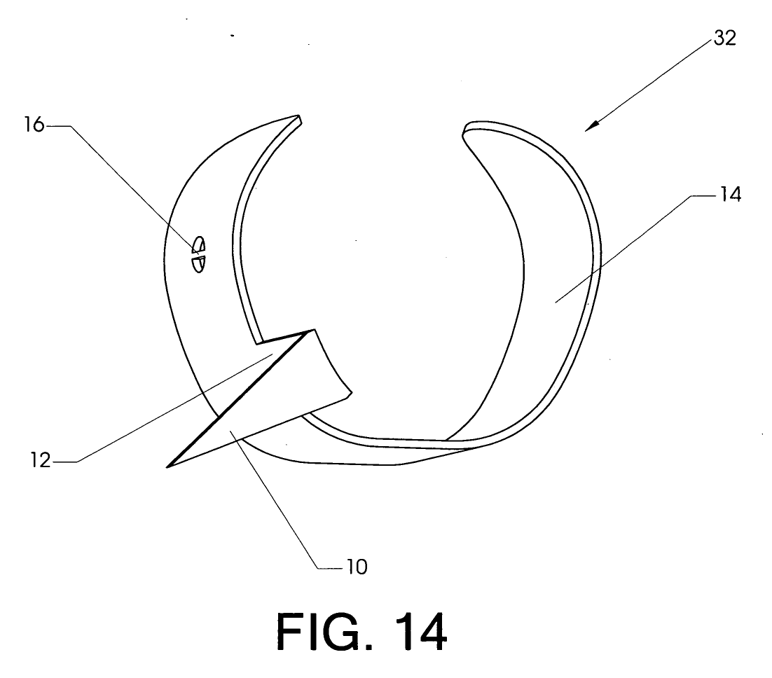

FIG. 14 illustrates a stylus in which tip 10 extends outward in a direction approximately perpendicular to the wrap's central axis. In this embodiment tongue 12 and tip 10 are offset to the right or left of wrap 14. A user may be more comfortable utilizing tip 10 in this position due to the natural alignment of digit 18 with hand-held device 20. Tip 10 can also extend directly from wrap 14 eliminating the need for tongue 12.

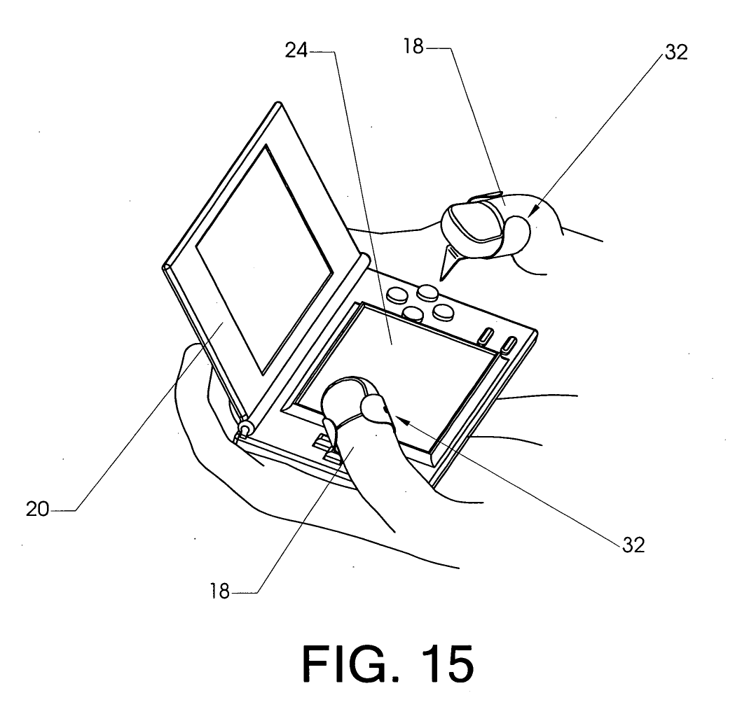

FIG. 15 illustrates a user operating hand-held device 20 while utilizing two digits 18. This is common for computer gaming devices such as those used in the NINTENDO™ games. The use of two of stylus 32's in this manner allows a user better access to touch-screen 24 with both the left and right digit 18. This can result in enhanced game play for the user.

Having now provided an explanation of the features that the present disclosure has in common with the disclosure in copending application Ser. No. 11/807,417, a detailed explanation of the new features will be provided. FIGS. 16-23 illustrate these new features.

For many applications a single and relatively small point of contact is desired. FIG. 16 shows an embodiment which is newly presented in this disclosure. The reader will observe that tip 10 actually narrows at its distal extreme to form nipple 44. Nipple 44 is preferably made of a non-scratching material so that it will not mar the surface of the device it is used to actuate. Those skilled in the art will know that a softer material can be overmolded on top of a harder material to form the desired arrangement. Alternatively, a softer material can be attached using frictional engagement, a mechanical interlocking engagement, or an adhesive engagement.

The present invention preferably allows the use of different tips. FIG. 16 illustrates some features facilitating the use of such tips. Tip 10 is made up of tip body 46 and nipple 44. Nipple 44 extends from the distal end of tip body 46. Nipple 44 is preferably made up of a plastic or rubber material which allows the user to contact the touch screen surface without scratching it. The overall shape of tip 10 enables different accessories to be attached to tip 10.

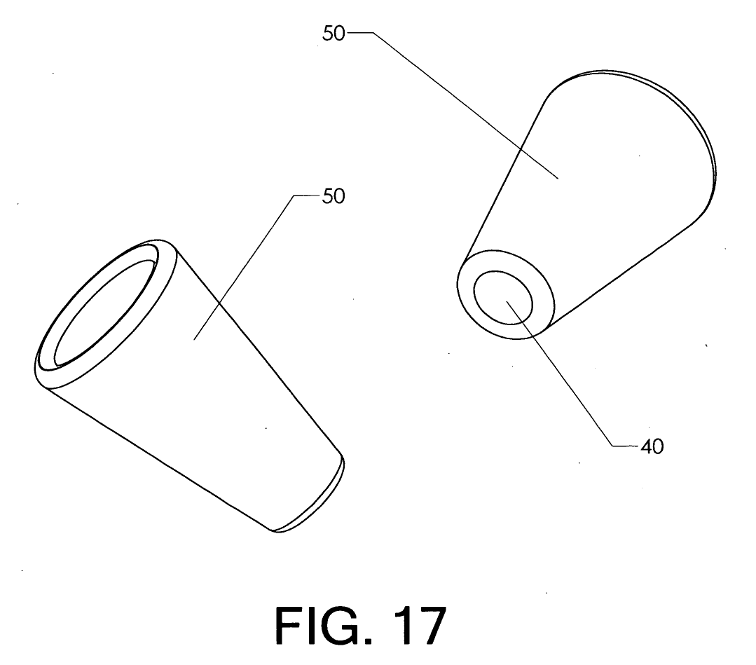

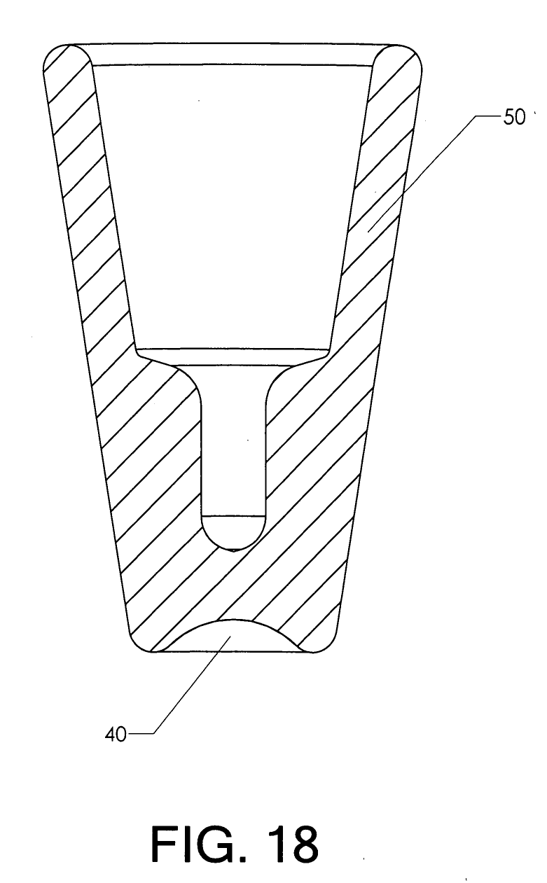

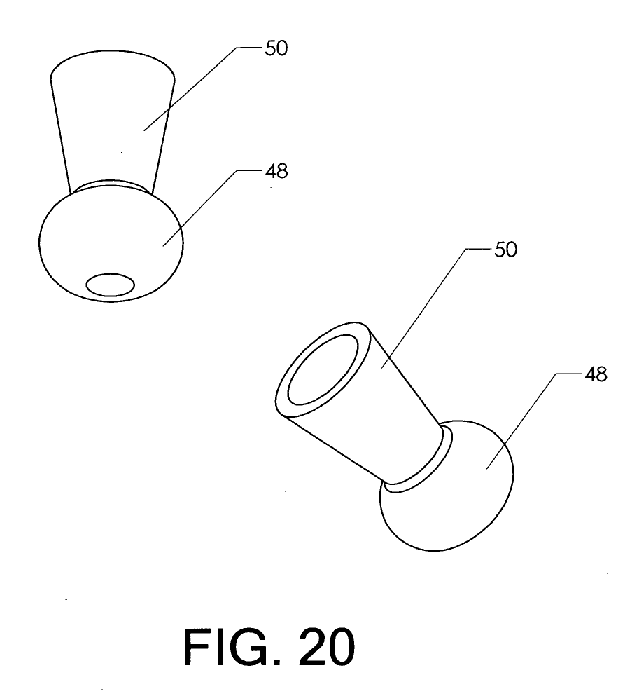

In FIG. 17 and FIG. 20 two such accessories are shown. In FIG. 17 cap 50 narrows to concave cup 40. As previously shown in FIG. 13 concave cup 40 can be used to contact a domed structure. FIG. 18 shows a section view through concave cup 40, so that its shape may be more easily seen. Cap 50 also includes a receiver that slips over and engages nipple 44. A frictional engagement may be sufficient to hold the cap in place, though in some cases it is preferable to add adhesive to the joint.

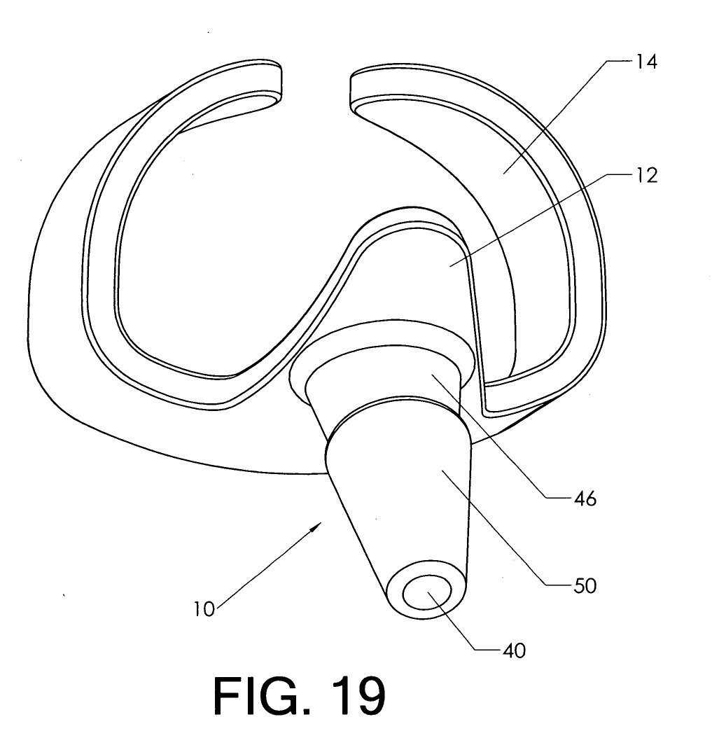

FIG. 19 shows the stylus with cap 50 installed on tip 10. The reader should note that the cap need not be made detachable. In fact, it is also possible to overmold cap 50 over tip 10 so that they become one integral unit. Such a version would lose the versatility of having interchangeable tips. However, since the stylus is a small and relatively inexpensive device, a user may opt to carry two or more of them (each having a particular style of tip).

FIG. 20 shows a different type of tip which is specifically configured for use with a capacitive touch screen. A capacitive touch screen presents unique challenges because in order for it to be actuated by a device touching it, the device must be (1) at least somewhat conductive; and (2) able to bridge a distance across the capacitive touch screen. The conductivity must be at least comparable to human skin (though it can be greater). The term “conductive” in this context should be understood to mean a conductivity at least as great as the conductivity of human skin under poor conditions. The distance to be bridged ranges from a minimum of about 2 mm to a maximum of about 20 mm. In other words, a single point of contact will not work.

Of course, one goal of the present invention is to provide rapid actuation of a capacitive touch screen. A rigid, planar contacting device will not work well for this, since the user would have to carefully align the plane of the contacting device with the plane of the touch screen. This cannot be done rapidly. In fact, the human finger tip provides a good model for the type of contacting device needed. The human finger tip is (1) at least mildly conductive; and (2) sufficiently pliable to flatten across a sufficient distance when pressed against a capacitive touch screen. The human finger tip essentially creates a conductive bridge from one portion of a touch screen to the other. The touch screen senses the presence of this conductive bridge and this fact allows the user to interact with the touch screen.

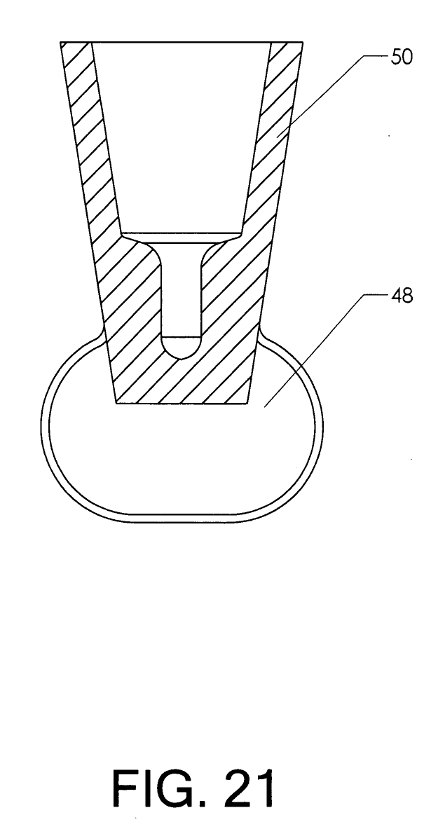

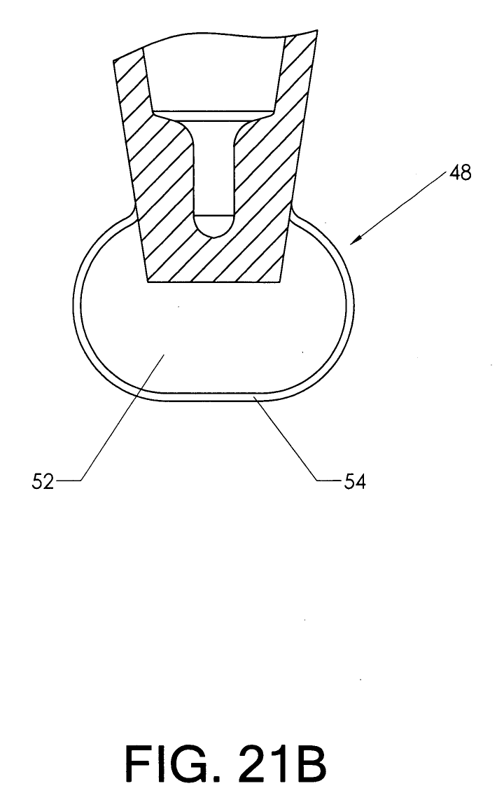

The device shown in FIG. 20 is pliable and has a conductive exterior. It includes a cap 50 with an attached conductive contactor 48. FIG. 21 shows a section view through the cap and the conductive contactor. The reader will observe that cap 50 includes internal features designed to slide over and engage tip body 46 and nipple 44 shown in FIG. 16. Returning to FIG. 21, the reader will observe that conductive contactor 48 covers the distal end of cap 50.

FIG. 21B is a more detailed view of the same cross section. The conductive contactor can be made of many different materials. One good approach is to use a resilient material 52 covered by pliable conductive layer 54. A good example of a suitable resilient material would be silicone or neoprene sponge. The conductive layer can be a mesh of fine conductive wires. As an example, Custom Shielding of Gilbert, Ariz., makes a mesh material of tin-plated bronze wires. Each wire has a diameter of about 0.005 inches and the mesh is created of wires spaced between about 0.010 inches and 0.050 inches apart.

A second approach is to use a spherical mass of pliable conductive wires, similar to very fine steel wool. Steel wool itself would not be preferable, since it would tend to corrode and might possibly abrade the touch screen surface. A mass of small copper wires would be preferable. The mass of fine wires would be attached to cap 50. The mass comprises interlocked and kinked strands, so that every strand is electrically connected to every other strand. The wires are very fine, so that the mass can easily deform when pressed against a solid object such as a capacitive touch screen.

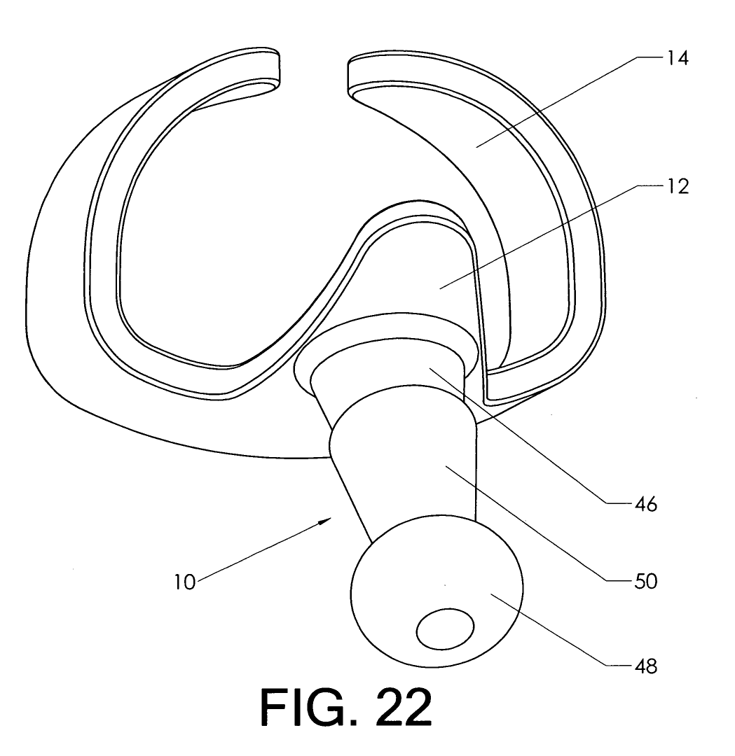

FIG. 22 shows conductive contactor 48 and cap 50 installed on a stylus. The reader should note that it is certainly possible to attach the conductive contactor directly to tip 10 without utilizing a separate cap. However, the use of a cap can be advantageous since it allows different contactors to be placed on a single tip. The conductive contactor shown in FIG. 22 can be the composite type as detailed in FIG. 21B, or alternatively a mass of interwoven conductive wires in the shape shown.

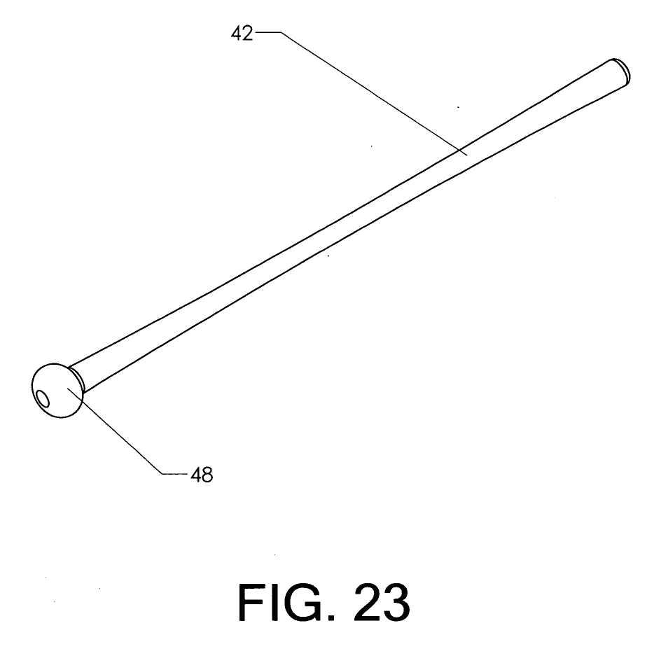

In FIG. 23 conductive contactor 48 is shown located at the end of a conventional stylus pen. The same types of conductive contactor can be applied to such a conventional stylus, using the structures disclosed in FIGS. 20-22. However, this device is not within the claims of the present invention.

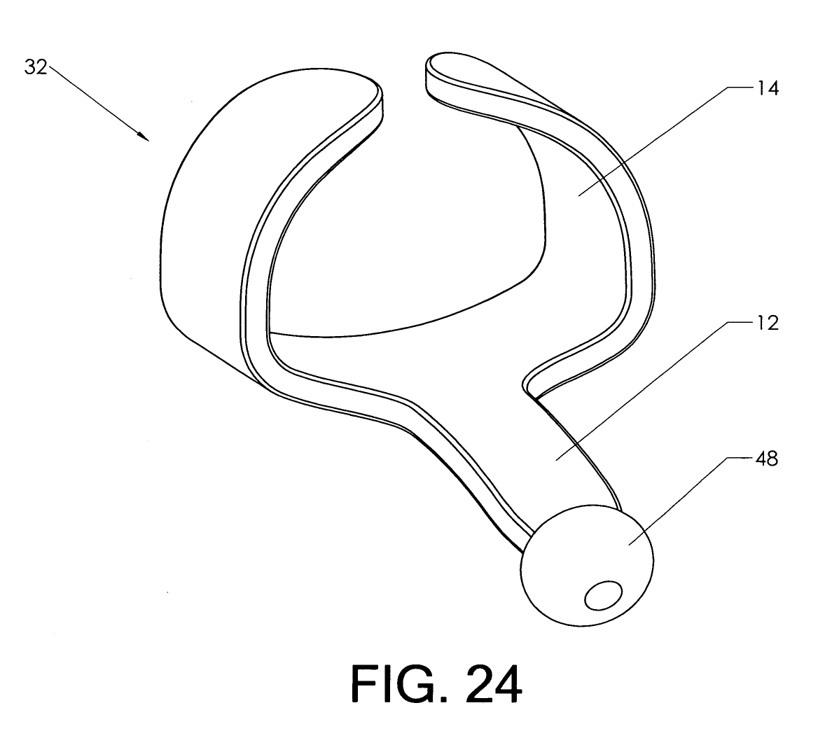

Finally, FIG. 24 illustrates an embodiment in which the conductive contactor is attached directly to a tongue. This embodiment includes a wrap 14 and a tongue 12 extending away from the wrap. Conductive contactor 48 is attached to the distal end of the tongue. Again, the conductive contactor can be any material (or a composite of multiple materials) which is both pliable and conductive. The tongue is shown extending away from the wrap in a direction which descends somewhat from the central axis of the wrap. This angle may be adjusted appropriately to suit user preferences. It could range from descending directly downward toward the hand-held device and away from the user's digit to ascending somewhat upward to wrap over a portion of the end of the user's digit. The conductive contactor could also be placed on any of the tips shown in the embodiments illustrated in FIGS. 1-15.

The preceding description contains significant detail regarding the novel aspects of the present invention. It should not be construed, however, as limiting the scope of the invention but rather as providing illustrations of the preferred embodiments of the invention. As an example, wrap 14 could be attached around digit 18 by way of a Velcro overlapping fabric situated around wrap 14. Additionally, tip 10 and conductive contactor 48 could be made in different lengths and thicknesses to correspond with different contact points on different types of touch-screen devices. Thus, the scope of the invention should be fixed by the following claims, rather than by the examples given.

Having described my invention, I claim:

1. A stylus allowing a user to operate a hand-held device having user-interface features responsive to physical contact, said user having a digit with a central axis, comprising:
a. a wrap configured to at least partially encircle said digit and frictionally engage said digit, said wrap having a central axis which is approximately aligned with said central axis of said digit when said wrap is installed on said digit;
b. at least one tip connected to said wrap, said at least one tip extending away from said wrap; and
c. a conductive contactor, located on said at least one tip in a position distal to said wrap, said conductive contactor being pliable and conductive.

2. A stylus as recited in claim 1, wherein said connection between said at least one tip and said wrap comprises a tongue extending away from said wrap in a direction which is approximately parallel to said central axis of said wrap.

3. The stylus of claim 1, wherein said wrap includes a lanyard hole for attachment to a lanyard.

4. The stylus of claim 1, wherein said at least one tip is laterally offset from said tongue.

5. The stylus of claim 1, wherein said at least one tip extends downward from said central axis of said wrap at an acute angle.

6. The stylus of claim 1, wherein said at least one tip extends downward from said central axis of said wrap at an obtuse angle.

7. The stylus of claim 1, wherein said conductive contactor comprises a core of resilient material covered by a pliable conductive layer.

8. The stylus of claim 1, wherein said conductive contactor comprises a mass of pliable conductive wires.

9. The stylus of claim 2, wherein said conductive contactor comprises a core of resilient material covered by a pliable conductive layer.

10. The stylus of claim 2, wherein said conductive contactor comprises a mass of pliable conductive wires.

11. The stylus of claim 3, wherein said conductive contactor comprises a core of resilient material covered by a pliable conductive layer.

12. The stylus of claim 3, wherein said conductive contactor comprises a mass of pliable conductive wires.

13. The stylus of claim 4, wherein said conductive contactor comprises a core of resilient material covered by a pliable conductive layer.

14. The stylus of claim 4, wherein said conductive contactor comprises a mass of pliable conductive wires.

15. A stylus allowing a user to operate a hand-held device having user-interface features responsive to physical contact, said user having a digit with a central axis, comprising:
a. a wrap configured to at least partially encircle said digit and engage said digit, said wrap having a central axis which is approximately aligned with said central axis of said digit when said wrap is installed on said digit;
b. a tongue, having a proximal end attached to said wrap and a distal end extending away from said wrap; and
c. a conductive contactor connected to said distal end of said tongue, said conductive contactor being pliable and conductive.

16. A stylus as recited in claim 15, wherein said connection between said conductive contactor and said distal end of said tongue is made by a tip attached on one end to said tongue and on the other end to said conductive contactor.

17. A stylus as recited in claim 16, wherein said tip is laterally offset from said tongue.

18. A stylus as recited in claim 15, wherein said tongue extends away from said wrap in a direction which is approximately parallel to said central axis of said wrap.

19. The stylus of claim 15, wherein said conductive contactor comprises a core of resilient material covered by a pliable conductive layer.

20. The stylus of claim 15, wherein said conductive contactor comprises a mass of pliable conductive wires.
